(19) United States
(12) Patent Application Publication
(10) Pub. No.: US 2003/0218674 A1
(43) Pub. Date: Nov. 27, 2003

(54) Method and apparatus for video georegistration

(75) Inventors: Wenyi Zhao, Somerset, NJ (US); Bogdan Matei, North Brunswick, NJ (US); Ying Shan, West Windsor, NJ (US); Stephen Charles Hsu, Cranbury, NJ (US); Michael W. Hansen, Newtown, PA (US)

Correspondence Address: MOSER, PATTERSON & SHERIDAN, LLP, /SARNOFF CORPORATION, 595 SHREWSBURY AVENUE, SUITE 100, SHREWSBURY, NJ, 07702, US

(73) Assignee: Sarnoff Corporation

(21) Appl. No.: 10/443,513

(22) Filed: May 22, 2003

Related U.S. Application Data
(60) Provisional application No. 60/382,962, filed on May 24, 2002.

(51) Int. Cl. H04N 7/18

(52) U.S. Cl. 348/140

(57) ABSTRACT

A method and apparatus for performing georegistration using both a telemetry based rendering technique and an interative rendering technique. The method begins with a telemetry based rendering that produces reference imagery that substantially matches a view being imaged by the camera. The reference imagery is rendered using the telemetry of the present camera orientation. Upon obtaining a certain level of accuracy, the method proceeds to perform iterative rendering. During iterative rendering, the method uses image motion information from the video to enhance rendering of the reference imagery. A further embodiment uses sequential statistical framework to provide a unified approach to georegistration.

### CROSS-REFERENCE TO RELATED APPLICATIONS

This application claims benefit of United States provisional patent application serial No. 60/382,962 filed May 24, 2002, which is herein incorporated by reference.

### GOVERNMENT RIGHTS IN THIS INVENTION

This invention was made with U.S. government support under contract number DAAB07-01-C-K805. The U.S. government has certain rights in this invention.

### BACKGROUND OF THE INVENTION

1. Field of the Invention

The present invention generally relates to image processing. More specifically, the invention relates to a method and apparatus for improved speed, robustness and accuracy of video georegistration.

2. Description of the Related Art

The basic task of video georegistration is to align two-dimensional moving images (video) with a three-dimensional geodetically coded reference (an elevation map or a previously existing geodetically calibrated reference image such as a co-aligned digital orthoimage and elevation map). Two types of approaches have been developed using these two types of references. One approach considers either implicit or explicit recovery of elevation information from the video for subsequent matching to a reference elevation map. This approach of directly mining and using 3D information for georegistration has the potential to be invariant to many differences between video and the reference; however, the technique relies on the difficult task of recovering elevation information from video. A second approach applies image rendering techniques to the input video based upon input telemetry (information describing the camera's 3D orientation) so that the reference and video can be projected to similar views for subsequent appearance based matching. In practice, such method has demonstrated to be fairly robust and accurate.

A video georegistration system generally comprises a common coordinate frame (CCF) projector module, a preprocessor module and a spatial correspondence module. The system accepts input video that is to be georegistered to an existing reference frame, telemetry from the camera that has captured the input video and the reference imagery or coordinate map onto which the video images are to be mapped. The reference imagery and video are projected onto a common coordinate frame based on the input telemetry in the CCF projector. This projection establishes initial conditions for image-based alignment to improve upon the telemetry-based estimates of georegistration. The projected imagery is preprocessed by the preprocessor module to bring the imagery under a representation that captures both geometric and intensity structure of the imagery to support matching of the video to the reference. Geometrically, video frame-to-frame alignments are calculated to relate successive video frames and extend the spatial context beyond that of any single frame. For image intensity, the imagery is filtered to highlight pattern structure that is invariant between the video and the reference. The preprocessed imagery is then coupled on to the spatial correspondence module wherein a detailed spatial correspondence is established between the video and the reference that results in an alignment (registration) of these two forms of data.

The image rendering (performed at the CCF projector) is performed once and purely based on telemetry, e.g., the measured orientation of the camera. The system is theoretically limited to quasi-3D framework. That is, the system is accepting only 3D rendered images and two-dimensional registration; therefore, a true three-dimensional representation is not completely formed. Additionally, if the rendered (or projected) image that is based on camera telemetry is not close to the true camera position, an unduly high error differential between the captured data (video) and the “live” data (telemetry) will cause system instability or require a high degree of repetition of such processing to allow the system to accurately map the video to the reference.

The shortcomings of the presently available georegistration systems can be better described as follows. A good starting point (between the captured video and the telemetry supplied) is important to obtain initially accurate and robust results. However, the system is not always reliable because the telemetry (i.e., GPS signals) may only be relayed to a station or otherwise updated once a minute whereas typical georegistration devices process many frames of video between updates. Accordingly, if the video image changes and the supplied telemetry does not change at the same (appreciable) rate, a registration error will occur. Another potential source of error can come from the telemetry equipment. That is, a GPS satellite may transmit bad (or no) data at a given interval or reception of GPS signals may be impaired at the camera location. Any attempts to register video information with such erroneous data will result in a poor georegistration of the involved video frames. To compensate for these errors in robustness or accuracy, additional image rendering iterations must be performed before a reliable georegistration can occur.

As such, there is a need in the art for a system that performs video georegistration in a fast, robust and accurate manner.

### SUMMARY OF THE INVENTION

The disadvantages of the prior art are overcome by a method and apparatus for performing georegistration using both a telemetry based rendering technique and an iterative rendering technique. The method begins with a telemetry based rendering that produces reference imagery that substantially matches a view being imaged by the camera. The reference imagery is rendered using the telemetry of the present camera orientation. The method produces a quality measure that indicates the accuracy of the registration using telemetry. If the quality measure is above a first threshold, indicating high accuracy, the method proceeds to perform iterative rendering. During iterative rendering, the method uses image motion information from the video to refine the rendering of the reference imagery. Iterative rendering is performed until the quality measure exceeds a second threshold. The second threshold indicates higher accuracy than the first threshold. If the quality measure falls below the first threshold, the method returns to using the telemetry to perform rendering.

In a second embodiment of the invention, a unified approach is used to perform georegistration. The unified approach relies on a sequential statistical framework that adapts to various imaging scenarios to improve the speed and robustness of the georegistration process.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts a block diagram of a system for performing video georegistration in accordance with the present invention;

FIG. 2 is a block diagram of the software that performs the method of the present invention;

FIG. 3 depicts a flow diagram of a method of performing a bundle adjustment process within the correspondence registration module of FIG. 2; and

FIG. 4 depicts a block diagram of a sequential statistical framework of a second embodiment of the invention.

### DETAILED DESCRIPTION

The present invention is a method and apparatus for registering video frames onto reference imagery (i.e., an orthographic and/or elevation map).

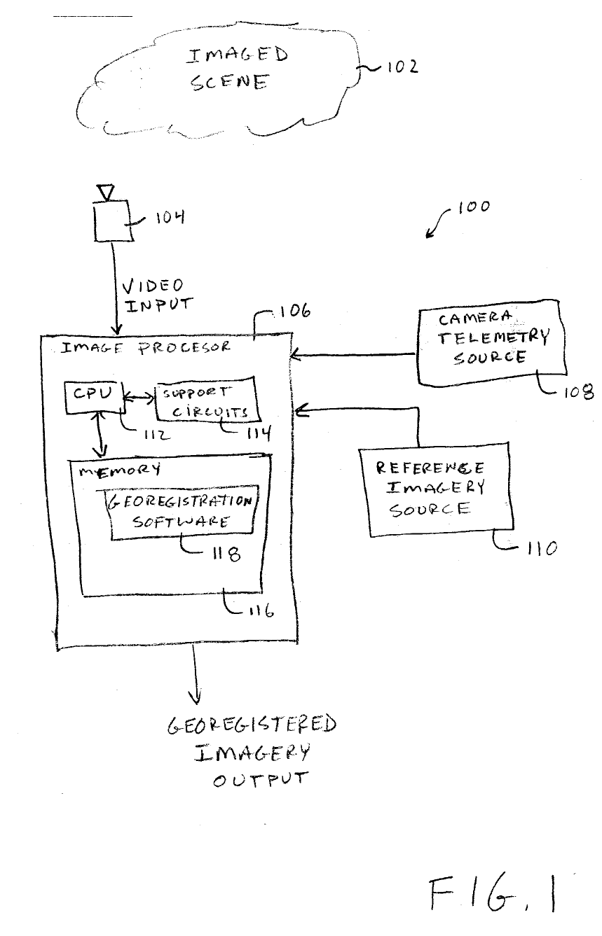

FIG. 1 depicts a video georegistration system 100 that is capable of georegistering video of an imaged scene 102 with reference imagery such as an orthographic and/or elevation map representation of the scene. The system 100 comprises a camera 104 or other image sensor and image processor 106. A camera telemetry source 108 and a reference imagery source 110. The camera 104 produces video images in the form of a stream of video frames. The camera telemetry source 108 produces camera orientation information for the camera 104. The camera telemetry source 108 may comprise a global positioning system receiver or other form of camera position generating equipment as well as sensors that provide pan, tilt and zoom parameters of the camera 104. In short, the camera telemetry source provides camera pose information for the image processor 106. The reference imagery source 110 is a source of orthographic and/or elevation map information that is generally stored in a database (e.g., the reference imagery may be two dimensional and/or three dimensional imagery). The image processor 106 selects reference imagery that coincides with the view of the scene produced by the camera 104. Since the reference imagery database does not contain imagery pertaining to all views, the image processor 106 must render a view for the reference imagery that matches the view of the camera 104. The image processor 106 then registers the video frames with the rendered reference imagery to produce a georegistered imagery output.

The image processor 106 comprises a central processing unit 112, support circuits 114 and a memory 116. The CPU 112 may be any one of a number of computer processors such as microcontrollers, microprocessors, application specific integrated circuits, and the like. The support circuits are well known circuits that are used to provide functionality to the CPU 112. The support circuits 114 comprise such circuits as cache, clock circuits, input/output circuits, power supplies, and the like. The memory 116 stores software as executed by the CPU to perform the georegistration function of the image processor 106. Georegistration software 118 is stored in memory 116 along with other software such as operating systems (not shown).

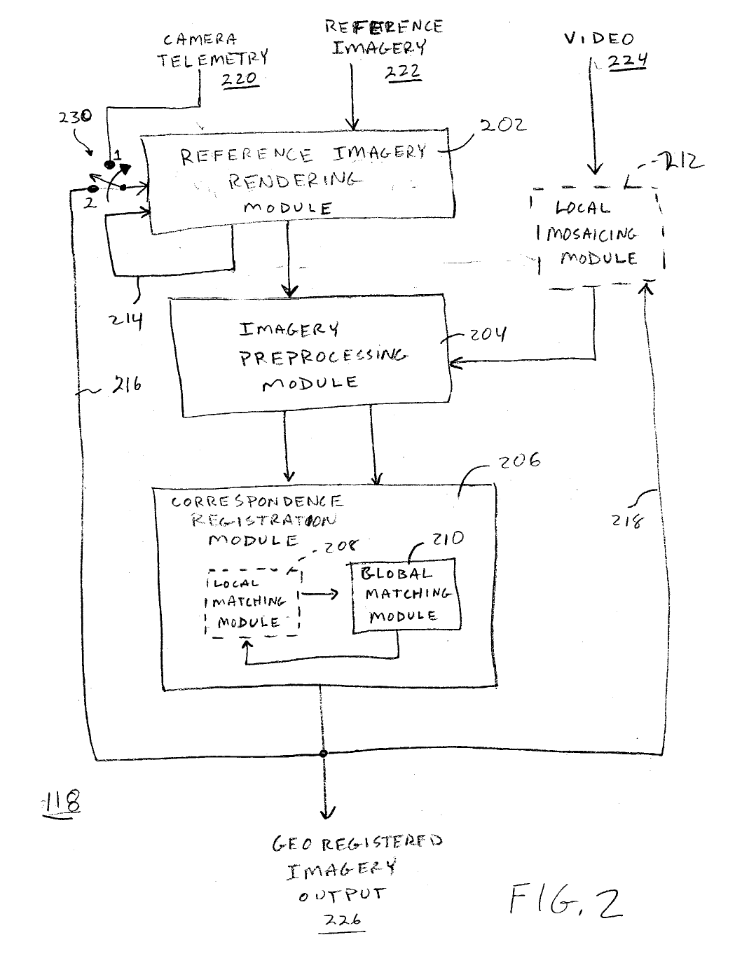

FIG. 2 depicts a block diagram of the functional modules that comprise the georegistration software 118 of FIG. 1. The functional modules of the software 118 comprise a reference imagery rendering module 202, an imagery preprocessing module 204, a correspondence registration module 206 and, optionally, a local mosaicing module 212. The function of each of these interconnected modules provide the software 118 with the ability to manipulate data representative of two-dimensional imagery and three-dimensional position location information in such a manner to more accurately register the two-dimensional video information to the three-dimensional reference imagery information while maintaining a reasonable processing speed, registration accuracy and robustness.

In a first embodiment of the invention, the video 224 is applied directly to the imagery preprocessing module 204. The local mosaicing module 212 is an optional implementation that is described below. The imagery preprocessing module 204 also accepts an input from the reference imagery rendering module 202 that will be described below. For now, suffice it to say that the rendering module 202 produces a reference imagery having a view substantially similar to that of the video. The video 224 and the rendered reference imagery are preprocessed to produce a representation that captures both geometric and intensity structure of the imagery to support matching of the video information to the rendered reference imagery. The preprocessing module 204 insures that brightness differences between the imagery in the video 224 and the rendered reference imagery are equalized before the correspondence registration module 206 processes the images. Brightness differences between the video and the reference imagery can cause anomalies in the registration process. The preprocessing module 204 may also provide filtering, scaling, and the like.

The correspondence registration module 206 aligns the rendered reference imagery with the video 224 using a global matching module 210. Optionally, a local matching module 208 may also be used. The alignment and fusing of the rendered reference imagery with the video imagery may be performed as described in commonly assigned U.S. Pat. Nos. 6,078,701, 6,512,857 and U.S. patent application Ser. No. 09/605,915, all of which are incorporated herein by reference. The output of the correspondence registration model 206 is georegistered imagery 226. The georegistered imagery is coupled along path 216 and through switch 230 to the reference imagery rendering module 202 thereby using a prior registered image to correct and update the rendered reference imagery. Initially, the camera telemetry 220 is used to render the reference imagery. As such, the switch 230 initially is in position 1 to couple the telemetry to the rendering module 202. Subsequently, the switch is moved to position 2 to couple the georegistered imagery 226 to the rendering module 202. Of course, the switch 230 is a metaphor for the selection process performed in software to select either the camera telemetry 220 or georegistered imagery 226. Once the georegistered imagery 226 is selected, an iterative alignment process is used to accurately produce rendered reference imagery that matches the view in the video. The iterations are performed along path 214. In this manner, the rendered reference imagery can be made to more accurately correspond to the video that is input to the imagery preprocessing module 204, thus improving the speed, robustness and accuracy of the correspondence registration process performed in module 206.

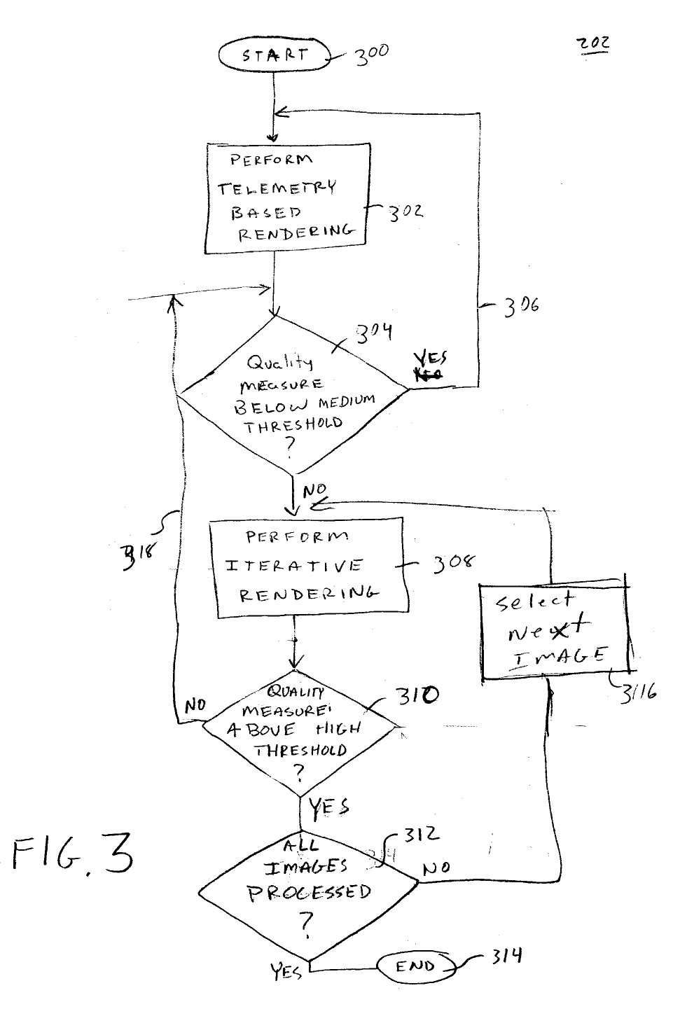

FIG. 3 depicts a flow diagram of the process used in the reference imagery rendering module 202 to render a reference image that accurately portrays an orthographic image and/or elevation map corresponding to the video frames being received at the input. The process begins at step 300 and proceeds to step 302 wherein the method 202 performs telemetry based rendering. Telemetry based rendering is a well-known process that uses telemetry information concerning the orientation of the camera (e.g., x, y, z coordinates as well as pan, tilt and zoom information) to render reference imagery for combination with the input video.

The telemetry-based rendering uses a standard texture map-based rendering process that accounts for 3D information by employing both orthoimage and co-registered elevation map. The orthoimage is regarded as a texture, co-registered to a mesh. The mesh vertices are parametrically mapped to an image plane based on the telemetry implied from a camera projection matrix. Hidden surfaces are removed via Z-buffering. Denoting input world points as m_{w}_{ⱼ} and output projected reference points as mᵣ_{ⱼ}, the output points are computed by:

$${m}_{{r}_{j}} = {m}_{{w}_{j}} \times {P}_{w , r}^{render} \qquad ( 1 )$$

The projection matrix (P) relating these two points is represented as:

$${P}_{w , r}^{render} = ( \begin{matrix}{a}_{11} & {a}_{12} & {a}_{13} & {a}_{14} \\ {a}_{21} & {a}_{22} & {a}_{23} & {a}_{24} \\ 0 & 0 & 0 & 1 \\ {a}_{41} & {a}_{42} & {a}_{43} & {a}_{44}\end{matrix} ) \qquad ( 2 )$$

At step 304, a quality measure (q) is computed and compared to a medium threshold to identify when the telemetry based rendering is relatively accurate (as defined below with respect to Equation 6). If the quality measure is below a threshold, then the telemetry based rendering is continued until the quality measure is high enough to indicate rendering using the telemetry-based process is complete. The method 202 then performs an iterative rendering process at step 308 that further completes the rendering process to form an accurate reference image.

In the interative rendering process, the projection matrix is computed using the following iterative equation

$${P}_{w , r}^{irender} = {F}_{v - {v}_{0} , v}^{affine} \times {Q}_{r - 1 , v - {v}_{0}} \times {P}_{ω , r - 1}^{irender} \qquad ( 3 )$$

where

$${P}_{ω , r - 1}^{irender}$$

is the previous projection matrix used for rendering, Q_{r-1,ν} is the global matching result that maps between the (projected) reference(s) r−1 and video frames ν-ν₀, and

$${F}_{v - {v}_{0} , v}^{affine}$$

is the cascaded affine projection between video frames ν-ν₀ and ν. To use this iterative rendering technique, the process starts from the telemetry-based rendering, i.e.,

$${P}_{ω , 0}^{irender} = {P}_{ω , 0}^{render} .$$

The matrix definitions are as follows:

$$\begin{matrix}{F}_{υ , v + 1}^{affine} = ( \begin{matrix}{c}_{11} & {c}_{12} & 0 & {c}_{13} \\ {c}_{21} & {c}_{22} & 0 & {c}_{23} \\ 0 & 0 & 1 & 0 \\ 0 & 0 & 0 & 1\end{matrix} ) & ( 4 ) \\ {Q}_{r , v} = ( \begin{matrix}{b}_{11} & {b}_{12} & 0 & {b}_{14} \\ {b}_{21} & {b}_{22} & 0 & {b}_{24} \\ 0 & 0 & 1 & 0 \\ {b}_{31} & {b}_{32} & 0 & {b}_{34}\end{matrix} ) & ( 5 )\end{matrix}$$

Using iterative rendering, the method propagates the camera model that is initiated by telemetry and compensated by georegistration. To determine if the iterative rendering process is to stop, the process proceeds to step 310 where the quality measure is compared to a high threshold. If the high quality measure is exceeded, the process proceeds to step 312. Otherwise, the process proceeds to step 304. The quality measure is based on the confidence scores of georegistration and cascaded frame-to-frame motion. Iterative rendering achieves system speed, robustness and accuracy.

After each iterative rendering step, the process proceeds along path 318 to have the rendering output tested by steps 310 and 304 to see if it meets the medium and high quality measure standard. If for some reason, the image was not rendered to closely match the view of the camera, the method 202 will return to the telemetry based rendering process of step 302. This may occur when video is captured that does not match the prior reference imagery, i.e., a substantial change in the scene or camera orientation.

The iterative rendering technique relies on accurate cascaded frame-to-frame motion to achieve accurate rendering. In practice, the quality of cascaded frame-to-frame motion is not always guaranteed. The accumulations of small errors in frame-to-frame motion could lead to large error in the cascaded motion. Another case to consider is when any one of the frame-to-frame motions is broken, e.g., the camera is rapidly sweeping across a scene. In such cases, telemetry is better used even though it does not produce a result that is as accurate as iterative rendering. Mathematically, the queries at steps 304 and 310 are represented as:

$${P}_{ω , r}^{srender} = \{ \begin{matrix}{P}_{ω , r}^{irender} , & if {q}_{req , f 2 f} is above a medium threshold ; \\ done , & if {q}_{req , f 2 f} is above a high threshold or \\ & a preset iteration number is reached ; \\ {P}_{ω , r}^{render} , & otherwise\end{matrix} \qquad ( 6 )$$

where q_{req,f2f} is a quality measure based on the confidence scores of previous georegistration and cascaded frame-to-frame motion.

If the quality measure is high or a predefined number of iterations are performed, then the iterative rendering is deemed complete at step 310 and the method 202 will query whether all images have been processed. If they have not been all processed, then the query at step 312 is negatively answered and the method 202 proceeds to step 316 wherein the next image is selected from the input images for processing. The new image is processed using the iterative rendering technique of step 308 and checked against the quality measures in steps 304 and 310. If one of the new images does not correspond to the imagery that was previously processed, the quality measure indicates that the image does not correspond well with the prior rendering. As such, the telemetry based rendering process is used. If all the images are processed, the procedure of process 202 stops at block 314.

The arrangement of FIG. 2 can be enhanced by using an optional local mosaicing module 212. The use of a local mosaicing module will enhance processing under narrow field of view conditions. The local mosaicing module accumulates a number of input frames of video, aligns those frames, and fuses the frames into a mosaic. Such mosaic processing is described in U.S. Pat. No. 5,649,032, issued Jul. 15, 1997 and incorporated herein by reference.

To further enhance the accuracy of the georegistration performed by the system, the correspondence process can be enhanced by performing sequential statistical approaches to iteratively align the video with the reference imagery within the global matching module 210.

An ultimate video georegistration system is based on sequential Bayesian framework. Adopting a Bayesian framework allows us to use error models that are not Gaussian but more close to the “real” model. But even with a less complicated sequential statistical approach such as Kalman filtering, certain advantages exist. Although exemplary implementations of the Bayesian framework are disclosed below, those details should not be interpreted as limitations of such framework. Based on particular applications, different implementations may be adopted.

There are many reasons for considering such a sequential statistical framework. Such processes provide an even faster algorithm/system. For example, if the qualities of both frame-to-frame motion and previous georegistration are good, then the process can propagate the previous georegistration result through frame-to-frame motion to directly obtain the current registration result. Of course, such propagation ignores the probabilistic nature of georegistration. To model such probabilistic propagation is exactly what sequential statistical approaches do. For example, sequential Bayesian methods propagate probability. With the assumption of probability being Gaussian, it reduces to Kalman methods that propagate the second-order statistics.

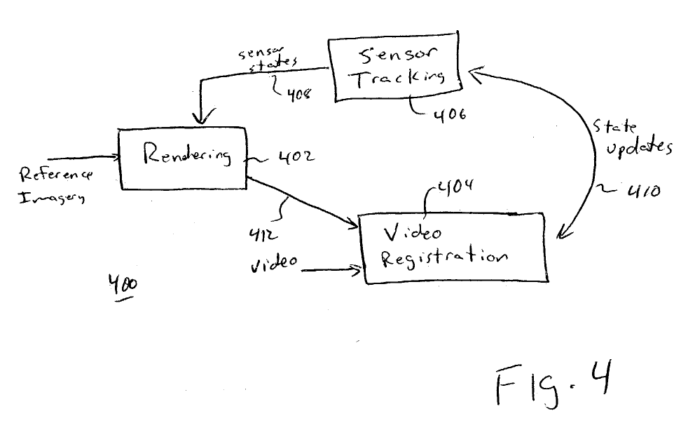

FIG. 4 depicts a block diagram of one embodiment of a sequential statistical framework 400 that use state based rendering. The framework 400 comprises a rendering module 402, a video registration module 404 and a sensor tracking module 406. The rendering module 402 renders the reference imagery into a view from the sensor using the sensor states (path 408). The sensor states are produced by the sensor tracking module 406. These states are initialized using physical sensor pose information. However, the states are updated using information on path 410 that results from the video registration process. The rendering reference imagery is coupled along path 412 from the rendering module 402 to the video registration module 404. The video registration module 404 registers the video to the rendered reference imagery and produces state updates for the sensor tracking module 406 that enable the rendering process to be improved. As is discussed below, the state updates are defined by the extent of information that is available to produce the updates.

Another reason for using such a framework is the need to have a principled and unified way to handle video georegistration under different scenarios. As such, the technique is flexible and resilient. A unified framework can take into account different scenarios and handles the scenarios in a continuous (probabilistic) manner. To make this point clear, we summarize some typical scenarios in Table 1.

TABLE 1

| | frame-to-frame | frame-to-reference |
|---|---|---|
| Scenarios | motion | registration |
| Pure Propagation | no | no |
| Constrained | yes | no |
| Propagation | | |
| Pure Control | no | yes |
| Controlled Propagation | yes | yes |

From table 1, there are two types of information available, frame-to-frame motion, and registration of frame-to-reference (hence video to world). And in real applications, all, either or none of them could be available. For example, in the pure propagation scenario, none of the information is available and in the controlled propagation scenario, all registration information is available. The same statistical framework is used to model both scenarios with the only difference being the values of parameters.

A dynamic system can be described by a general state space model as follows:

xₙ=f(xₙ₋₁, rₙ) (7)

yₙ=h(xₙ, qₙ) (8)

where x is the state vector and r is the system noise, y is the observation vector and q is the observation. f and h are possibly nonlinear functions.

The most important problem in state space modeling is the estimation of the state xₙ from the observations. The problem of state estimation can be formulated as an evaluation of the conditional probability density p(xₙ|Yₜ), where Yₜ is the set of observations {y₁, . . . ,yₜ}. Corresponding to three distinct cases, n>t, n=t, and n<t, the estimation problem can be classified into the three corresponding categories where p(xₙ|Yₜ) is called the predictor, the filter and the smoother, respectively.

For the standard linear-Gaussian state space model, each density is assumed to be a Gaussian density and its mean vector and the covariance matrix can be obtained by computationally efficient recursive formula such as the Kalman filter and smoothing algorithms that assume Markovian dynamics. To handle nonlinear-Gaussian state space model where either or both f and h are nonlinear, extended Kalman filter (EKF) can be applied. More specifically, the original state space model is as follows

xₙ=f(xₙ₋₁)+rₙ (9)

yₙ=h(xₙ₋₁)+qₙ (10)

and the locally-linearized model is

$$\begin{matrix}{x}_{n} = {F}_{n - 1} {x}_{n - 1} + {r}_{n} + [ f ( {\hat{x}}_{n - 1 \vert n - 1} ) - {F}_{n - 1} {\hat{x}}_{n - 1 \vert n - 1} ] & ( 11 ) \\ {y}_{n} = {H}_{n} {x}_{n} + {q}_{n} + [ h ( {\hat{x}}_{n \vert n - 1} ) - {H}_{n} {\hat{x}}_{n \vert n - 1} ] & ( 12 )\end{matrix}$$

where F and H are Jacobian matrices derived from f and h respectively.

For non-Gaussian state space model, sequential Monte Carlo method that utilizes efficient sampling techniques can be used.

To make the sequential statistical framework clear, an embodiment under different scenarios is described. Without losing generality, the EKF solution is described. As we mentioned earlier, other solutions and implementations are possible and perhaps more appropriate depending on particular applications.

A typical video georegistration system has a flying platform that carries sensors including GPS sensor, inertial sensor and the video camera. The telemetry data basically consists of measurements from all these sensors, e.g., location of the platform (latitude, longitude, height and focal length of the camera). The telemetry-based rendering/projection matrix P_{ω,r}^{render} is computed from this. Based on such configuration of the system, one choice of the state vector would be defined by the whole physical system, i.e., location of the platform, orientation and focal length of the camera. To make the model more flexible in handling nonlinear motions of the physical system, the speed and acceleration of these physical states can be incorporated into the state vector. The approach linearizes the generally nonlinear system with first and second order order dynamics. One possible choice of the state vector would be the zero-order, first-order and second-order of the physical states of the system. In general, the following equations define the system dynamics:

$$\{ \begin{matrix}{s}_{n} = {s}_{n - 1} + {v}_{n} \\ {v}_{n} = {v}_{n - 1} + {α}_{n} \\ {α}_{n} = {α}_{n - 1} + {w}_{n}\end{matrix} \qquad ( 13 )$$

where vₙ is the velocity of sₙ and αₙ is the acceleration of sₙ, and wₙ is the noise term. Altogether, {sₙ, vₙ, αₙ} make up the state vector xₙ. For example, the physical position of the platform consists of three components, latitude, longitude and height. And each of these component has three parts in the state vector: position, velocity and acceleration. Similarly, each component of the sensor orientation and focal length could have three parts in the state vector. It is also possible that second-order representation for sensor orientation might bring too much fluctuation than desired. Hence the trade-off is to have system stability in stead of system flexibility.

As we will see below, the common part for all these scenarios is the system dynamics (Eq. 13) and the different part is the form of observation equation.

The possible forms of the observation equation under different scenarios are illustrated to show they all can be unified via changing the values of parameters.

First in the case of pure propagation, there is no frame-to-frame motion and frame-to-reference registration, the mapping function H would be simply an identity matrix that propagates previous state to the current state based on the system dynamics. Even in such case, the sequential approach is useful in that erroneous telemetry data could be filtered out.

Second in the case of constrained propagation, the only available information is the frame-to-frame motion. Now the H mapping function can be computed easily from the frame-to-frame motion. For example, the corner points in previous frame form the input and corner points in the current frame form the output. And the input and output are linked by the observation equation.

$${m}_{n}^{out} = {H}_{n} {m}_{n}^{i n} + {q}_{n} + [ ⋯ ] \qquad ( 14 )$$

where [. . . ] denotes the difference between linear term and the original non-linear term, mₙ^{out} are a group of points on frame n and mₙⁱⁿ are a group of points on frame n−1. These points can be computed from telemetry data at frames n and n−1.

The first two scenarios could be categorized as sensor tracking in a sense that sensor/telemetry have been tracked without the involvement of the registration of video frame to reference.

The third case of pure control could be classified as video registration since it is here the video frame was registrated to reference that is associated with the world coordinate. Here, the system dynamics are deactivated, and the H mapping function in the observation equation is totally controlled by the result of frame-to-reference registration. The inputs are points at frame n and outputs are the corresponding points on the reference.

Finally, the case of controlled propagation involves both video registration and sensor tracking. Here the inputs are points at frames {n-n₀, . . . , n}, the outputs are corresponding points on references {r-r₀, . . . , r}.

To unify the different scenarios, Eq. 14 is interpreted as follows: mₙ^{out} are a group of points on references {r-r₀, . . . , r}, and mₙⁱⁿ are a group of points on frames {n-n₀, . . . , n}. In case of pure propagation, the frame is identical to reference and the observation dynamics is effectively deactivated by setting the covariance matrix Qₙ of the noise qₙ to be infinity. In the case of constrained propagation, again the frame is identical to the reference and the mapping function is determined by frame-to-frame motion, the covariance matrix Qₙ of the noise qₙ is determined by the quality of the frame-to-frame motion. Next, in the case of pure control, the system dynamics is effectively deactivated by setting the covariance matrix Rₙ of the noise rₙ (or wₙ) to be infinity. Finally, in the case of controlled propagation, both the system dynamics and observation dynamics are active, and the variance values of the noise rₙ and qₙ are determined by the qualities of frame-to-frame motion and frame-to-reference registration. Table 2 summarizes these special treatments under the same sequential statistical framework for different scenarios.

TABLE 2

| | system | observation |
|---|---|---|
| Scenarios | dynamics | dynamics |
| Pure Propagation | | Q_{r,v} = I and Qₙ = ∞I |
| Constrained | | Q_{r,v} = I |
| Propagation | | |
| Pure Control | Rₙ = ∞I | |
| Controlled Propagation | | |

From the unified framework for performing sequential statistical video georegistration, it is straightforward to see that the smart rendering that requires a hard switch function of the first embodiment of the invention is replaced with rendering from the estimated states in the second embodiment. All together, they form a system that can easily handle different scenarios seamlessly.

Though the proposed sequential statistical framework has so many advantages, it does need to estimate the values of various parameters. For example, the noise covariance matrices of Rₙ and Qₙ control the behavior of the system. These matrices need to be estimated, perhaps very frequently. One challenge for implementing a fast system is the fast estimation of the dynamic parameters. It is always true that the more observations used, the better parameter estimation that can be expected, assuming the statistics do not change during the observation period. However, there are two potential issues. The first is the speed requirement for the system does not allow for long delay of parameter estimation. The second is that the statistics could change over a long period of time, challenging the validity of parameter values estimated. In general, the EM (expectation-maximization) algorithm (well known in the art) provides a framework to perform parameter estimation to fulfill both of these issues.

While foregoing is directed to various embodiments of the present invention, other and further embodiments of the invention may be devised without departing from the basic scope thereof, and the scope thereof is determined by the claims that follow.

1. A method of performing video georegistration comprising:
providing a sequence of video frames;
providing a first reference imagery;
providing telemetry for a sensor that produced the sequence of video frames;
rendering a second reference imagery from the first reference imagery that has a viewpoint of the sensor, the rendering is performed using the telemetry for the sensor;
producing a quality measure that indicates the quality of the viewpoint of the second reference imagery; and
upon the quality measure exceeding a threshold, rendering the second reference imagery using iterative rendering.

2. The method of claim 1 further comprising:
registering the second reference imagery with each of the video frames in the sequence of video frames.

3. The method of claim 2 further comprising:
prior to registering, pre-processing the sequence of video images and the second reference imagery.

4. The method of claim 3 wherein the pre-processing comprises at least one process selected from the group of filtering, brightness adjustment, and scaling.

5. The method of claim 2 wherein the rendering step utilizes sequential statistical processing.

6. The method of claim 5 wherein the sequential statistical processing uses a Baessian framework.

7. The method of claim 2 wherein the registering step further comprises:
global matching elements of the images in the sequence of images and the second reference imagery; and
local matching elements of the images in the sequence of images and the second reference imagery.

8. The method of claim 1 further comprising forming a mosaic from a plurality of images in the sequence of images.

9. The method of claim 1 wherein the first and second reference imagery comprises at least one of three dimensional imagery, or two dimensional imagery.

10. Apparatus for performing video georegistration comprising:
a sensor that provides a sequence of video frames;
a database that provides a first reference imagery;
a telemetry source for producing telemetry for the sensor that produced the sequence of video frames;
a reference imagery rendering module for rendering a second reference imagery from the first reference imagery that has a viewpoint of the sensor, the rendering is performed using the telemetry for the sensor, and for producing a quality measure that indicates the quality of the viewpoint of the second reference imagery, and, upon the quality measure exceeding a threshold, rendering the second reference imagery using iterative rendering.

11. The apparatus of claim 10 further comprising:
a correspondence module for registering the second reference imagery with each of the video frames in the sequence of video frames.

12. The apparatus of claim 11 further comprising:
a pre-processor, coupled to between the reference imagery rendering module and the correspondence module, for pre-processing the sequence of video images and the second reference imagery.

13. The apparatus of claim 12 wherein the pre-processor performs at least one process selected from the group of filtering, brightness adjustment, and scaling.

14. The apparatus of claim 10 further comprising a mosaic generator for forming a mosaic from a plurality of images in the sequence of images.

15. The apparatus of claim 10 wherein the first and second reference imagery comprises at least one of three dimensional imagery or two dimensional imagery.

16. A method for performing video georegistration comprising:
(a) initializing state variables using telemetry of a sensor;
(b) rendering reference imagery that produces reference imagery having a viewpoint of a sensor using the state variables;
(c) registering video produced by the sensor with the rendered reference imagery;
(d) using the registered video to update the state variables; and
(e) repeating steps (a), (b), (c), and (d) to improve registration between the reference imagery and the video.

17. The method of claim 16 wherein the rendering and registering steps are performed using a state space model.

18. The method of claim 17 wherein the state space model is an extended Kalman filter.

19. The method of claim 16 wherein the reference imagery comprises at least one of two-dimensional imagery or three-dimensional imagery.
